(19) United States
(12) Patent Application Publication
(10) Pub. No.: US 2002/0128837 A1
(43) Pub. Date: Sep. 12, 2002

(54) Voice binding for user interface navigation system

(76) Inventor: Philippe Morin, Santa Barbara, CA (US)

Correspondence Address: HARNESS, DICKEY & PIERCE, P.L.C., P.O. BOX 828, BLOOMFIELD HILLS, MI, 48303, US

(21) Appl. No.: 09/803,870

(22) Filed: Mar. 12, 2001

(51) Int. Cl. G10L 15/28; G10L 15/00

(52) U.S. Cl. 704/255

(57) ABSTRACT

The voice binding system associates spoken commands of a user's choosing with the semantic path or sequence used to navigate through a menu structure associated with the electronic device. After storing this association, the user can later navigate to the tagged location in the menu structure by simply uttering the spoken command again. Spoken commands are stored during the record mode in a lexicon that is later used by the speech recognizer. The voice binding database stores associations of voice commands and semantic strings, where the semantic strings correspond to the menu text items found in the linked list associated with the devices menu.

### BACKGROUND OF THE INVENTION

The present invention relates generally to user interface technology for electronic devices. More particularly, the invention relates to a voice binding system to allow the user of an electronic product, such as cellular telephone, pager, smart watch, personal digital assistant or computer, to navigate through menu selection, option selection and command entry using voice. The system associates user-defined spoken commands with user-selected operations. These spoken commands may then be given again to cause the system to navigate to the designated operation directly. In this way, the user no longer needs to navigate through a complex maze of menu selections to perform the desired operation. The preferred embodiment uses speech recognition technology, with spoken utterances being associated with semantic sequences. This allows the system to locate designated selections even in the event other items are added or removed from the menu.

Users of portable personal systems, such as cellular telephones, personal digital assistants (PDAs), pagers, smart watches and other consumer electronic products employing menu displays and navigation buttons, will appreciate how the usefulness of these devices can be limited by the user interface. Once single purpose devices, many of these have become complex multi-purpose, multi-feature devices (one can now perform mini-web browsing on a cellular phone, for example). Because these devices typically have few buttons, the time required to navigate through states and menus to execute commands is greatly increased. Moreover, because display screens on these devices tend to be comparatively small, the display of options may be limited to only a few words or phrases at a time. As a consequence, menu structures are typically deeply nested. This “forced navigation” mode is not user friendly since typically users want to perform actions as fast as possible. From that standpoint, state/menu driven interfaces are not optimal for use. However, they do offer a valuable service to users learning to use a system's capabilities. Ideally, a user interface for these devices should have two user modes: a fast access mode to access application commands and functions quickly, and a user-assisting mode to teach new users in system use by providing a menu of options to explore. Unfortunately, present day devices do not offer this capability.

The present invention seeks to alleviate shortcomings of current interface design by providing a way of tagging selected menu choices or operations with a personally recorded voice binding “shortcuts” or commands to speed up access to often used functions. These shortcuts are provided while leaving the existing menu structure in tact. Thus, new users can still explore the system capabilities using the menu structure. The voiced commands can be virtually any utterances of the user's choosing, making the system easier to use by making the voiced utterances easier to remember. The user's utterance is input, digitized and modeled so that it can then be added to the system's lexicon of recognized words and phrases. The system defines an association or voice binding to the semantic path or sequence by which the selected menu item or choice would be reached using the navigation buttons. Thereafter, the user simply needs to repeat the previously learned word or phrase and the system will perform recognition upon it, look up the associated semantic path or sequence and then automatically perform that sequence to take the user immediately to the desired location within the menu.

For a more complete understanding of the invention, its objects and advantages, refer to the following specification and the accompanying drawings.

### BRIEF DESCRIPTION OF THE DRAWINGS

FIG. 1 is an illustration of an electronic device (a cellular telephone) showing how the voice binding system would be used to navigate through a menu structure;

FIG. 2 is a block diagram of a presently preferred implementation of the invention;

FIG. 3 is a data structure diagram useful in understanding how to implement the invention; and

FIG. 4 is a state diagram illustration the functionality of one embodiment of the invention in a consumer electronic product.

### DETAILED DESCRIPTION OF THE PREFERRED EMBODIMENTS

The voice binding technology of the invention may be used in a wide variety of different products. It is particularly useful with portable, hand-held products or with products where displayed menu selection is inconvenient, such as in automotive products. For illustration purposes, the invention will be described here in a cellular telephone application. It will be readily appreciated that the voice binding techniques of the invention can be applied in other product applications as well. Thus, the invention might be used, for example, to select phone numbers or e-mail addresses in a personal digital assistant, select and tune favorite radio stations, select pre-defined audio or video output characteristics (e.g. balance, pan, bass, treble, brightness, hue, etc.), select pre-designated locations in a navigation system, or the like.

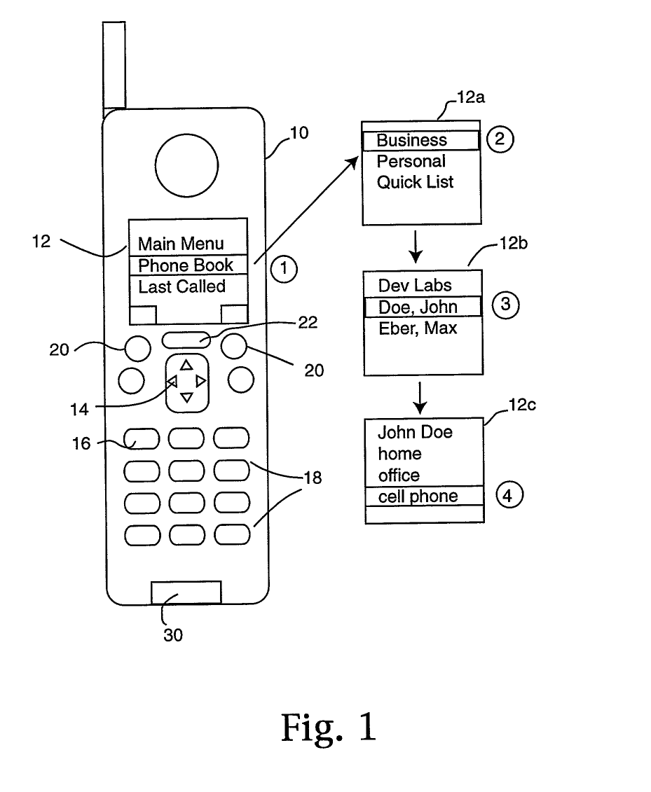

Referring to FIG. 1, the cellular telephone 10 includes a display screen 12 and a navigation button (or group of buttons) 14, as well as a send key 16, which is used to dial a selected number after it has been entered through key pad 18 or selected from the PhoneBook of stored numbers contained within the cellular phone 10. Although not required, the phone also includes a set of softkeys 20 that take on the functionality of the commands displayed on display 12 directly above the softkeys 20. Telephone 10 also includes a voice binding ASR (automatic speech recognition) button 22. This button is used, as will be described more fully below, when the user wishes to record a new voice command in association with a selected entry displayed on the display 10.

To illustrate, assume that the user plans to make frequent calls to John Doe through John's cell phone. John Doe is a business acquaintance; hence, the user has stored John Doe's cellular telephone number in the on-board PhoneBook under the “Business” contacts grouping. The user has configured the telephone 10 to awaken upon power up with a displayed menu having “PhoneBook” as one of the displayed choices, as illustrated at 1. The user manipulates navigation button 14 until the PhoneBook selection is highlighted and then further manipulates navigation button 14 (by navigating or scrolling to the right) revealing a second menu display 12a containing menu options “Business,” “Personal,” and “Quick List.” The user manipulates navigation button 14 until the Business selection is highlighted as at 2. The user then scrolls right again to produce the list of business contacts shown in menu screen 12b. Scrolling down to select “Doe, John,” the user then highlights the desired party as at 3 and then scrolls right again to reveal menu screen 12c. In this screen, all of John Doe's available phone numbers may be accessed. The user scrolls down to the cell phone number as at 4. The user may then press the send key 16 to cause John Doe's cell phone number to be loaded into the dialing memory and the outgoing call to be placed.

The above-described sequence of steps may be semantically described as follows:

Main Menu (root node of menu tree)

PhoneBook

Business

Doe, John

Cell Phone

To create a voice binding command for the above semantic sequence, the user would place the system in voice binding record mode by pressing the ASR button 22 twice rapidly. The system then prompts the user to navigate through the menu structure as illustrated in FIG. 1 until the desired cell phone number is selected as at 4. The system stores semantically the sequence navigated by the user. Thus the system would store the sequence: /PhoneBook/Business/Doe, John/Cell Phone. If a voice binding for that sequence has already been recorded, the system notifies the user and allows the user to replay the recorded voice binding command. The system also gives the user the option of deleting or re-entering the voice binding.

If a voice binding has not been previously recorded for the semantic sequence entered, the system next prompts the user to speak the desired voice binding command into the mouthpiece 30 of the telephone. The user can record any utterance that he or she wishes. Thus, the user might speak, “John Doe's mobile phone.” As will be more fully explained, the user's utterance is processed and stored in the telephone device's non-volatile memory. In addition, the user's voiced command is stored as an audio waveform, allowing it to be audibly played back so the user can verify that the command was recorded correctly, and so the user can later replay the commend in case he or she forgets what was recorded. In one embodiment, the system allows the user to identify whether the voice binding should be dialogue context dependent or dialogue context independent.

A dialogue context independent voice binding defines the semantic path from the top level menu. Such a path may be syntactically described as /s1/s2/ . . . /sn. The example illustrated in FIG. 1 shows a context independent voice binding. A dialogue context dependent voice binding defines the semantic path from the current position within the menu hierarchy. Such a path may be syntactically described as s1/s2/ . . . /sn. (Note the absence of the root level symbol ‘/’ at the head of the context dependent path). An example of a context dependent voice binding might be a request for confirmation at a given point within the menu hierarchy, which could be answered, “yes.”

Later when the user wishes to call John Doe's cell phone, he or she presses the ASR button 22 once and the system prompts the user on screen 10 to speak a voice command for look up. The user can thus simply say, “John Doe's mobile phone”, and the system will perform recognition upon that utterance and then automatically navigate to menu screen 12c, with cell phone highlighted as at 4.

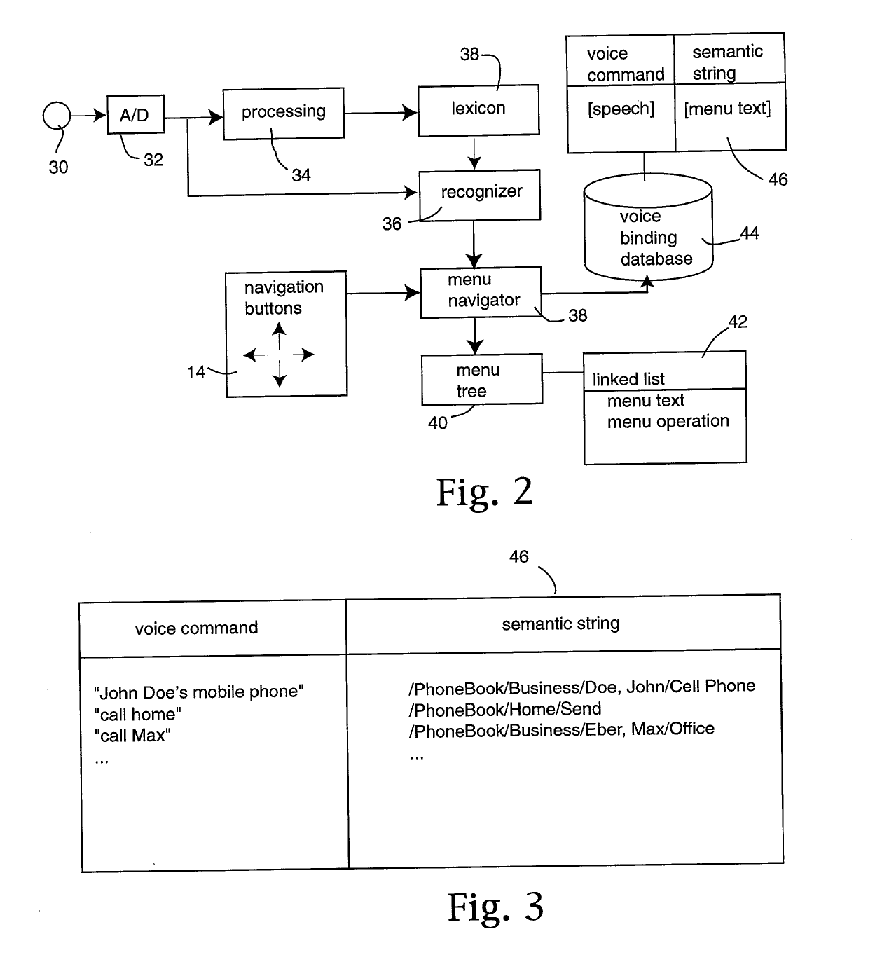

FIG. 2 shows a block diagram of the presently preferred implementation of a voice binding system. Speech is input through the mouthpiece 30 and digitized via analog to digital converter 32. At this point, the digitized speech signal may be supplied to processing circuitry 34 (used for recording new commands) and to the recognizer 36 (used during activation). In a presently preferred embodiment, the processing circuitry 34 processes the input speech utterance by building a model representation of the utterance and storing it in lexicon 38. Lexicon 38 contains all of the user's spoken commands associated with different menu navigation points (semantic sequence leading to that point). Recognizer 36 uses the data in lexicon 38 to perform speech recognition on input speech during the activation mode. As noted above, the defined voice bindings may be either dialogue context dependent, or dialogue context independent.

Although speaker-dependent recognition technology is presently preferred, other implementations are possible. For example, if a comparatively powerful processor is available, a speaker independent recognition system may be employed. That would allow a second person to use the voice bindings recorded by a first person. Also, while a model-based recognition system is presently preferred, other types of recognition systems may also be employed. In a very simple implementation the voice binding information may be simply stored versions of the digitized input speech.

The system further includes a menu navigator module 38 that is receptive of data signals from the navigation buttons 14. The menu navigator module interacts with the menu-tree data store 40 in which all of the possible menu selection items are stored in a tree structure or linked list configuration. An exemplary data structure is illustrated at 42. The data structure is a linked list containing both menu text (the text displayed on display 12) and menu operations performed when those menu selections are selected.

The menu navigator module 38 maintains a voice binding database 44 in which associations between voiced commands and the menu selection are stored. An exemplary data structure is illustrated at 46. As depicted, the structure associates voice commands with semantic strings. The voice command structure is populated with speech and the semantic string structure is populated with menu text. During the recording of new commands, the output of recognizer 36 is stored in the voice command structure by the menu navigator module 38. Also stored is the corresponding semantic string comprising a concatenated or delimited list of the menu text items that were traversed in order to reach the location now being tagged for voice binding.

FIG. 3 illustrates several examples of the voice binding database in greater detail. In FIG. 3 there are three examples of different voice commands with their associated semantic strings. For example, the voice command “John Doe's mobile phone” is illustrated as the first entry in data structure 46. That voiced command corresponds to the semantic string illustrated in FIG. 1, namely:

/PhoneBook/Business/Doe,John/Cell Phone.

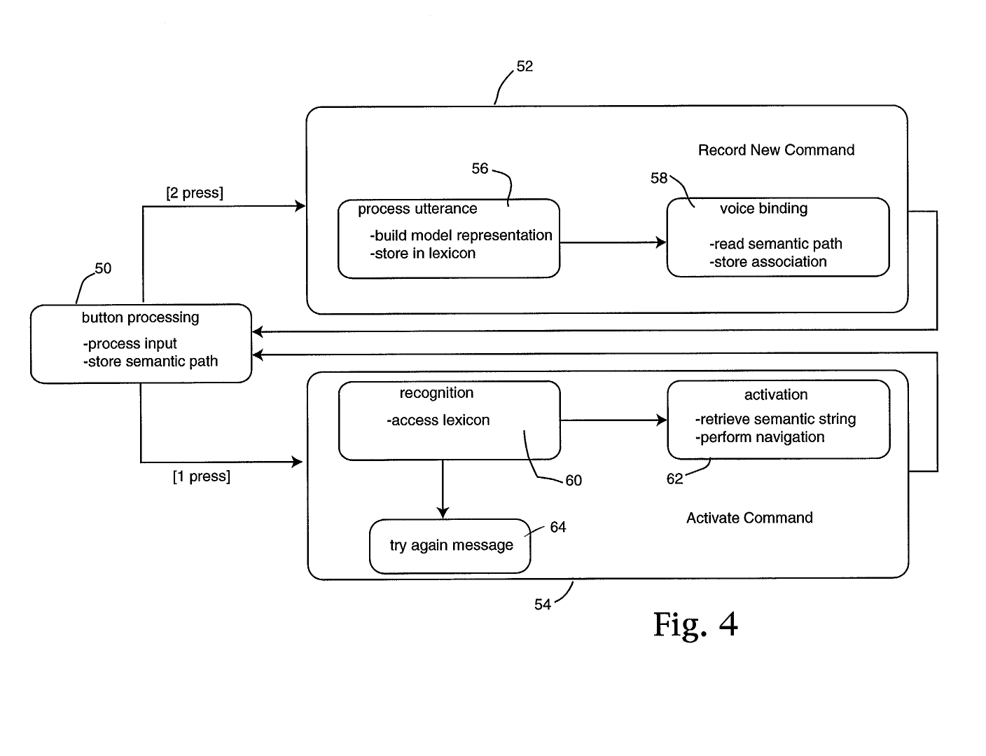

FIG. 4 shows a state diagram of the illustrated embodiment. When the system is first initialized, the state machine associated with the voice binding system begins in a button processing state 50. The button processing state processes input from the navigation buttons 14 (FIGS. 1 and 2) and stores the semantic path information by accessing the menu trees linked list 42 (FIG. 2) and building a semantic string of the navigation sequence. Thus, if the user navigates to the “PhoneBook” menu selection, the button processing state will store that text designation in the button state data structure.

The button processing state is continually updated, so that anytime the voice binding ASR button 22 is pressed, the current state can be captured. The state is maintained in reference to a fixed starting point, such as the main menu screen. Thus, the semantic path data store maintains a sequence or a path in text form on how to reach the current button state.

If the user presses ASR button 22 twice rapidly, the state machine transitions to the record new command state 52. Alternatively, if the user presses ASR button 22 once, the state machine transitions to the activate command state 54.

The record new command state comprises two internal states, a process utterance state 56 and a voice binding state 58. Prior to processing an utterance from the user, the system asks the user to enter the menu sequence. If the menu sequence had already been defined, the system notifies the user and the associated audio waveform is played back. The system then presents a menu or prompt allowing the user to delete or re-record the voice binding. If the menu sequence was not previously defined, the system allows the user to now do so. To record a new voice binding command the process utterance state 56 is first initiated. In the process utterance state 56, a model representation of the input utterance is constructed and then stored in lexicon 38 (FIG. 2.). In the voice binding state 58, the semantic path data structure maintained at state 50 is read and the current state is stored in association with the lexicon entry for the input utterance. The lexicon representation and stored association are stored as the voice command and semantic string in data structure 46 of the voice binding database 44 (FIG. 2).

The activate command state 54 also comprises several substates: a recognition state 60, a activation state 62 and a try again message state 64. In the recognition state, the lexicon is accessed by the recognizer to determine if an input utterance matches one stored in the lexicon. If there is no match, the state machine transitions to state 64 where a “try again” message is displayed on the display 12. If a recognition match is found, the state machine transitions to activation state 62. In the activation state, the semantic string is retrieved for the associated recognized voice command and the navigation operation associated with that string is performed.

For example, if the user depresses ASR button 22 for a short time and then speaks “John Doe's mobile phone,” the recognition state 60 is entered and the spoken voiced command is found in the lexicon. This causes a transition to activation state 62 where the semantic string (see FIG. 3) associated with that voice command is retrieved and the navigation operation associated with that string is performed. This would cause the phone to display menu 12c with the “Cell Phone” entry highlighted, as at 4 in FIG. 1. The user could then simply depress the send button 16 to cause a call to be placed to John Doe's cell phone.

The foregoing has described one way to practice the invention in an exemplary, hand-held consumer product, a cellular telephone. While some of the above explanation thus pertains to cellular telephones, it will be understood that the invention is broader than this. The voice binding techniques illustrated here can be implemented in a variety of different applications. Thus, the state machine illustrated in FIG. 4 is merely exemplary of one possible implementation, suitable for a simple one-button user interface.

If desired, the above-described system can be further augmented to add a voice binding feedback system that will allow the user to remember previously recorded voice binding commands. The feedback system may be implemented by first navigating to a menu location of interest and then pressing the ASR button twice rapidly. The system then plays back the audio waveform associated with the stored voice binding. If a voice binding does not exist at the location specified, the system will prompt the user to create one, if desired. In a small device, where screen real estate is at a premium, the voice bindings may be played back audibly through the speaker of the device while the corresponding menu location is displayed. If a larger screen is available, the voice binding assignments can be displayed visually, as well. This may be done by either requiring the user to type in a text version of the voiced command or by generating such a text version using the recognizer 36.

Although on-screen menus and displayed prompts have been illustrated in the preceding exemplary embodiments, auditory prompts may also be used. The system may playback previously recorded speech, or synthesized speech to give auditory prompts to the user. For example, in the cellular telephone application, prompts such as “Select phonebook category,” or “select Name to call” may be synthesized and played back through the phone's speaker. In this case the voice binding would become an even more natural mode of input.

To use the recognizer for voice binding textual feedback, the lexicon 38 is expanded to include text entries for a pre-defined vocabulary of words. When the voice binding database 44 is populated, the text associated with these recognized words would be stored as part of the voice command. This would allow the system to later retrieve those text entries to reconstitute (in text form) what the voice binding utterance consists of. If desired, the electronic device can also be configured to connect to a computer network either by data table or wirelessly. This would allow the voice binding feedback capability to be implemented using a web browser.

The voice binding system of the invention is reliable, efficient, user customizable and capable of offers full coverage for all functions of the device. Because speaker-dependent recognition technology is used in the preferred embodiment, the system is robust to noise (works well in noisy environments), tolerant to speaking imperfections (e.g., hesitations, extraneous words). It works well even with non-native speakers or speakers with strong accents. The user is completely free to use any commands he or she wishes. Thus a user could say “no calls” as equivalent to “silent ring.”

Voice bindings can also be used to access dynamic content, such as web content. Thus a user could monitor the value of his or her stock, by creating a voice binding, such as “AT&T stock” which would retrieve the latest price for that stock.

While the invention has been described in its' presently preferred embodiments, it will be understood that the invention is capable of certain modification without departing from the spirit of the invention as set forth in the appended claims.

I claim:

1. A method of navigating a menu structure within an electronic product, comprising the steps of:
identifying a first location within said menu;
obtaining a first utterance of speech;
associating said first utterance with said first location and generating therefrom a stored first location;
obtaining a second utterance of speech; and
matching said second utterance with said first utterance to identify said stored first location within said menu; and
navigating to said first location.

2. A method of navigating a menu structure within an electronic product, comprising the steps of:
identifying a user-selected navigation path through said menu structure to a first location within said menu;
obtaining a first utterance of speech;
associating said first utterance with said navigation path;
obtaining a second utterance of speech; and
matching said second utterance with said first utterance to retrieve said navigation path associated with said first utterance; and
using said retrieved navigation path to navigate to said first location within said menu.

3. The method of claim 2 further comprising storing said navigation path as a sequence of navigation steps leading to said first location.

4. The method of claim 2 further comprising storing said navigation path as a semantic sequence of navigation steps leading to said first location.

5. The method of claim 2 wherein said menu structure includes associated text and said method further comprises storing said navigation path as a semantic sequence of text associated with the navigation steps leading to said first location.

6. The method of claim 2 further comprising constructing a speech model associated with said first utterance and associating said speech model with said navigation path.

7. The method of claim 2 further comprising using a speech recognizer to compare said first and second utterances in performing said matching step.

8. The method of claim 2 further comprising constructing a speech model associated with said first utterance and using said speech model to populate the lexicon of a speech recognizer; and
using said speech recognizer to compare said first and second utterances in performing said matching step.

9. The method of claim 2 wherein said step of identifying a user-selected navigation path comprises displaying said first location on a visible display associated with said electronic product and prompting said user to provide said first utterance.

10. The method of claim 2 further comprising providing user feedback of the association between said first utterance and said navigation path by said first location on a visible display associated with said electronic product and producing an audible representation of said first utterance.

11. The method of claim 2 further comprising providing user feedback of the association between said first utterance and said navigation path by said first location on a visible display associated with said electronic product and producing a textual representation of said first utterance.

12. The method of claim 10 wherein said audible representation is provided by storing said first utterance as audio data and replaying said audio data at user request.

13. The method of claim 11 wherein said textual representation is provided using a speech recognizer.

14. The method of claim 11 wherein said textual representation is provided by storing text data associated with said first utterance and displaying said text data at user request.

15. A voice binding system to aid in user operation of electronic devices, comprising:
a menu navigator that provides a traversable menu structure offering a plurality of predefined menu locations;
a speech recognizer having an associated lexicon data store;
a processor for adding user-defined speech to said lexicon; and
a voice binding system coupled to said menu navigator for associating said user-defined speech with predetermined menu locations within said menu structure, operable to traverse to a predetermined menu location in response to a spoken utterance corresponding to said user-defined speech.

16. The voice binding system of claim 15 wherein said menu navigator includes at least one navigation button operable to traverse said menu structure.

17. The voice binding system of claim 15 wherein said voice binding system stores predefined menu locations as traversal path sequences.

18. The voice binding system of claim 15 wherein said voice binding system stores predefined menu locations as semantic sequences.

19. The voice binding system of claim 15 further comprising user feedback system operable to audibly reproduce the user-defined speech associated with predefined menu locations.

20. The voice binding system of claim 19 wherein said user-defined speech is stored as recorded speech waveforms and wherein said user feedback system replays said waveforms in response to user navigation to associated predefined menu locations.
